(19) United States
(12) Patent Application Publication
(10) Pub. No.: US 2024/0285126 A1
(43) Pub. Date: Aug. 29, 2024

(54) FOOD PROCESSING

(71) Applicant: DE'LONGHI BRAUN HOUSEHOLD GMBH, Neu-Isenburg (DE)

(72) Inventors: Daniel LEBSACK, Neu-Isenburg (DE); Gian Luca SILVESTRINI, Neu-Isenburg (DE)

(21) Appl. No.: 18/572,266

(22) PCT Filed: Nov. 14, 2022
(86) PCT No.: PCT/EP2022/081844

§ 371 Date: Dec. 20, 2023

(30) Foreign Application Priority Data
Dec. 1, 2021 (GB) 2117354.7
Dec. 13, 2021 (LU) LU102886

(51) Int. Cl. A47J 43/07; A47J 43/044

(52) U.S. Cl. CPC A47J 43/0711; A47J 43/044; A47J 2043/04436

(57) ABSTRACT

There is disclosed a food processing assembly. The assembly includes: a lid for a container, wherein the lid is adapted to receive a drive for driving a tool within the container; and a wiper for wiping an inner wall of the container.

### FIELD

The present invention relates to a food processing assembly, in particular an assembly including a wiper for wiping an inner wall of a container. The present invention also extends to a lid arrangement for a food processor.

### BACKGROUND

Food processors, including blenders, choppers, mixers and other appliances, typically include rotary tools that are driven to rotate in order to process food. In order to prevent food being processed by the food processor co-rotating with the tool, ribs are often provided extending along internal walls of the container within which food is processed, which act to block food rotating and redirect it back towards the tool.

Particularly (but not only) in food processing devices in which the container volume is limited and cylindrical, rotating food may act on the lid, or the lid may be driven to rotate with the food, or otherwise the lid may be driven to rotate. It is therefore desirable to secure the lid against rotation. It is also desirable to urge the food away from the lid, not only to stop the lid being moved but also to prevent the inner surface of the lid being coated by food or at least to reduce coating of the lid. This is especially important since most common food processor lids contain a gear system, making them non-dishwasher safe due to e.g., lubricants and corrodible metal parts, requiring manual cleaning by the user.

Additionally, it is a common problem of such devices that food is propelled towards the outside walls of the container by the rotary tool and sticks there. When this happens, this food cannot be reached by the tool anymore and is not processed any further, leading to an uneven result. To achieve an even result, the user needs to open the container during the processing to manually wipe down the stuck food from the walls, to allow further processing. Therefore it is desirable to provide a way for the user to wipe food downwardly from the internal container walls during use of the appliance. Particularly, it is desirable to provide a way of wiping down the container walls without having to open the container and without having to stop processing.

The present invention aims to at least partially ameliorate the above-described problems of the prior art.

### SUMMARY OF THE INVENTION

According to an aspect of the invention, there is provided a food processing assembly comprising: a lid for a container, wherein the lid is adapted to receive a drive for driving a tool within the container; and a wiper for wiping an inner wall of the container.

The lid may be adapted to receive a motor unit for driving a tool within the container. The lid may be adapted itself to drive a tool within the container (e.g. the lid may comprise the motor unit).

As used herein, the term “tool” preferably connotes a shaft for receiving drive, the shaft preferably being provided with one or more food processing tools (e.g. blades or paddles) for processing food.

The wiper preferably includes an aperture for receiving the tool and/or the drive. The aperture preferably extends through the wiper (i.e. is open at both ends).

The wiper preferably includes a drive extension adapted to transmit drive between the lid and the tool. The drive extension is preferably arranged to cover the aperture (i.e. to cover the side of the aperture facing the lid). Preferably, the drive extension is removably attachable to the wiper.

The wiper is preferably rotatable to wipe the inner wall of the container. The wiper is preferably rotatable independently of the tool and/or tool drive. The wiper may for example by manually rotatable. The wiper is preferably rotatable with the lid for wiping the inner wall of the container (i.e. the wiper is rotationally fixed relative to the lid, which is rotatable relative to the container). Preferably, the wiper is rotatable by rotating a means for driving the tool, received by the lid (e.g. a motor unit received by the lid). In other words, the wiper is preferably rotatable by rotating the drive (i.e. the drive unit in itself).

For example, the wiper may be movable by the user rotating the motor unit relative to the container. This is advantageous since the user may be required to grasp the motor unit during processing, for example in order to control the speed of the tool/tool drive. Therefore this may allow one-handed operation of the assembly, to operate either or both of the wiper and the processing tool. This reduces complexity of use for the user.

In addition, the wiper may be prevented from spinning in an uncontrolled manner because the action of the user holding the motor unit also holds the wiper in place.

The assembly may further comprise the container.

The arrangement is preferably such that rotation of the wiper relative to the container is restricted or limited. Preferably, the container and/or the wiper is adapted to restrict or limit rotation of the wiper relative to the container. The container may comprise one or more elements for restricting rotation of the wiper relative to the container, preferably wherein the restricting element comprises a rib on an inner wall of the container arranged to engage with or abut the wiper. For example the wiper may comprise at least one arm for wiping the inner wall of the container, which may cooperate with the rib(s). This may prevent the wiper from spinning in the container.

The arrangement is preferably such that the angle over which the wiper can rotate is limited, for example with the or each wiper arm being rotatable only between adjacent ribs.

The wiper is preferably selectively configurable between a fixed configuration in which the wiper is rotationally fixed relative to the container, and a rotating configuration in which the wiper is rotatable relative to the container. Preferably, the angle of rotation of the wiper relative to the container in the rotating configuration is limited (i.e. the wiper rotates only between a certain range of angles).

The assembly may further comprise the tool (and/or a tool for processing food in the container, adapted to receive drive from the lid); preferably wherein the wiper is adapted to permit driving of the tool when the wiper is in the container. In other words, the tool is preferably operable/drivable whilst the wiper is in the container. This allows the user to scrape off food from the container inner wall using the wiper, during processing of the food (e.g. while the tool is spinning). Preferably, arms of the wiper are arranged to not obstruct the tool. Preferably, the arms of the wiper terminate above the tool (e.g. blade or paddle), so as to prevent contact with the tool.

The assembly preferably further comprises the drive. Preferably, the drive is located on the lid.

Preferably, the wiper is associated with the lid. The wiper may be attached or attachable to the lid. The wiper may be movable with the lid for wiping the inner wall of the container. The wiper may be arrangeable/locatable between the lid and the container. The wiper may be arrangeable (or arranged) on the lid and/or on the container. The wiper may be attachable between the lid and the container. Optionally, the wiper is integral to (e.g. integrally formed with) the lid.

Preferably, the wiper is removably attachable to the lid. Preferably, the lid is adapted to seal the container.

Preferably, the wiper is removably attachable to the container. Preferably, the wiper is adapted to seal the container.

Preferably, the assembly is configurable in two configurations, wherein in a first configuration the lid is attached to the container, and in a second configuration the wiper is arranged between the lid and the container.

Preferably, the lid and/or wiper pivot relative to the container. Preferably, rotation of the lid and/or wiper relative to the container is restricted, more preferably to less than 360 degrees (i.e. the lid and/or wiper cannot freely rotate relative to the container). This is advantageous compared to arrangements in which the lid and wiper are free to rotate (over 360 degrees) upon application of a torque. In such arrangements, if torque is applied to the lid via scrapers of the wiper (e.g. through the food processed in the container, which can easily occur especially when hard solid food is processed), the lid can start to rotate, which might be confusing for the user and may cause injury to a user's hand that is holding the lid. Further, such free rotation reduces the efficiency of the food processing device.

The wiper is preferably removably attachable to the lid. Preferably, the wiper is adapted to cover an inner surface of the lid from the container (i.e. to cover the surface of the lid facing the container).

According to another aspect, there is provided a wiper for wiping an inner wall of a container having a lid, the wiper being removably attachable to the lid; and being adapted to cover an inner surface of the lid from the container, preferably to prevent said lid inner surface from coming into contact with food processed in the container.

The wiper is preferably removably attachable to the container, more preferably wherein the wiper is adapted to seal the container.

The wiper preferably includes a base plate. The base plate is preferably adapted to cover the inner surface of the lid from the container. In other words, the wiper (preferably the base plate thereof) acts as an intermediate lid.

Preferably, the base plate is adapted to seal the container. The base plate is preferably removably attachable to the lid. Preferably, the base plate is removably attachable to the container.

The wiper preferably includes one or more arms for wiping an inner wall of the container, preferably wherein the arms extend from a base plate. The wiper may include two or more arms, preferably three or more, more preferably six arms; preferably wherein the arms are arranged symmetrically around (a centre of) the wiper. Preferably, the arms have rotational symmetry of the same order as the number of arms (e.g. rotational symmetry of order 6 for a six-arm wiper).

The arms are preferably flexible. Each arm may comprise a rigid frame and a flexible element for wiping the inner wall of the container.

The arms are preferably flat. This prevents residue food collected behind the arms, and thus minimizes the wasting of food. Preferably, each arm is adapted to abut the container inner wall. Preferably, each arm is arranged parallel to the inner wall of the container, more preferably such that the entire arm abuts the inner wall of the container.

An, preferably each, arm may be adapted to engage with an engagement formation on the container to restrict movement, preferably rotation, of the wiper relative to the container. Preferably, an, more preferably each, arm comprises a recess adapted to engage a protrusion (i.e. an engagement formation)—e.g. a rib-on an inner surface of the container.

Preferably, the arms are further adapted to act as ribs for the container. The inner surface/contour of the arms may be arranged such that the arms operate as ribs to improve the processing of food in the container when the tool is in operation.

Preferably, each arm includes an axially-extending strengthening element. Preferably, the arms are thin (i.e. do not extend significantly away from the container inner wall), so as to not obstruct a tool in the container. Preferably, the arms are wide to enhance wiping. Preferably, the arms are adapted to direct food radially and/or axially away from the arms.

Preferably, the wiper is made of a food-safe and/or dishwasher-safe material.

According to another aspect, there is provided a food processing device comprising the food processing assembly as aforesaid or as described herein.

According to another aspect, there is provided a food processing assembly comprising: a container; and a wiper movable to wipe an inner wall of the container; wherein the arrangement is such that movement (preferably rotation) of the wiper relative to the container is restricted. In other words, the assembly is adapted to restrict movement of the wiper relative to the container.

Preferably, the container and/or the wiper are adapted to restrict movement of the wiper relative to the container.

Preferably, the wiper is rotatable to wipe the inner wall of the container. Preferably, the wiper is removably attachable to the container.

The wiper may be configurable between a first fixed/locked position in which it cannot rotate relative to the container, and a second rotating position in which it can rotate/pivot relative to the container. In the rotating position, the wiper (and lid) can preferably only rotate a certain degree. This improves safety of the arrangement because, even if the user attaches the lid in an incorrect position, the lid cannot start to rotate uncontrollably (since its angle of rotation is restricted). The ability to fixate the wiper (e.g. via engagement of the wiper's arms and ribs on the container) also makes the device particularly suitable for top-driven devices.

The wiper may include one or more arms for wiping the container inner wall. The container may be adapted to limit the angle over which the arms can rotate. The container may be adapted to lock the arms in place.

Preferably, the container comprises an inner surface provided with one or more ribs for restricting rotation of the wiper relative to the container. Preferably, the wiper comprises one or more arms for wiping the container inner wall adapted to rotate in between the ribs (i.e. the arms can rotate between the ribs but cannot rotate over the ribs, which thereby define the arms' angle of rotation). In other words, the maximum angle of rotation of the arms is given by the ribs of the container. Preferably, the arms are adapted to be lockable over the ribs, so as to prevent rotation of the wiper relative to the container. This allows use of the assembly in a static way-when the arms are arranged over the containers ribs, or in a dynamic way-when the arms are placed between the ribs.

According to another aspect, there is provided a wiper for wiping an inner wall of a container. The wiper is preferably rotatable to wipe an inner wall of the container.

Preferably, the wiper comprises a base plate and one or more (more preferably two or more) arms for wiping the container inner wall extending from the base plate.

Preferably, the wiper (preferably base plate thereof) is adapted to cover the container (i.e. the wiper optionally acts as intermediate lid). Preferably, the wiper is adapted to seal the container.

Preferably, the container includes a lid. The wiper is preferably removably attachable to the lid. Preferably, the base plate is adapted to substantially cover a surface of the lid facing the container, preferably to prevent said lid surface from coming into contact with food processed in the container.

Preferably, the wiper is attachable between the container and the lid. Preferably, the wiper is releasably attachable to the lid and/or container. Preferably, the wiper is separable from the lid and from the container, e.g. for cleaning.

According to another aspect, there is provided a wiper for wiping an inner wall of a container, wherein the wiper comprises an aperture for driving a tool within the container.

The aperture may be adapted to receive a drive for driving a tool within the container.

According to another aspect, there is provided a food processing container assembly comprising a container, a lid releasably attachable to the container so as to substantially seal it, and a wiper assembly rotatable to wipe an inner wall of the container, wherein in a first configuration the lid is attached directly to the container, and in a second configuration the wiper assembly is located between the lid and the container and the wiper assembly is actuatable to rotate through the lid.

Preferably, the wiper assembly comprises two or more axially-extending arms. Preferably, the container comprises ribs extending axially along an inner surface thereof, and the arms, in the second configuration, extend between the ribs to wipe therebetween, and more preferably the number of arms is equal to the number of ribs. Preferably, the arms comprise recesses configured to receive the ribs to lock therewith.

Preferably, the arms comprise resilient wipers mounted on rigid frame-elements. Preferably, the arms are shaped and configured such that food material encountering the arms is directed radially and/or axially away from the arms.

Preferably, the arms are at least three in number, and more preferably are six in number. Preferably, the arms are arrayed/arranged symmetrically about the lid.

Preferably, the arms are provided on a carriage of the wiper assembly, and the carriage is releasably attachable to the lid.

Preferably, the wiper assembly is actuatable to rotate relative to the lid from an opposite side of the lid to the wiper assembly.

Preferably, the lid further comprises a motor-unit attachment point, and a shaft and/or gearing configured for transmitting drive impetus from a motor unit mounted in the motor-unit attachment point to a tool located on an opposite side of the lid to the motor-unit attachment point. Preferably, the wiper assembly is actuatable to rotate via the motor-unit attachment point. Preferably, the motor-unit attachment point comprises releasable-attachment means for releasably attaching a motor-unit thereto.

Preferably, the assembly further comprises a rotary tool removably attachable to the container and/or lid.

According to another aspect, there is provided a food processing device comprising the food processing container assembly as described herein.

Any apparatus feature as described herein may also be provided as a method feature, and vice versa. As used herein, means plus function features may be expressed alternatively in terms of their corresponding structure, such as a suitably programmed processor and associated memory.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

The invention extends to methods, system and apparatus substantially as herein described and/or as illustrated with reference to the accompanying figures.

The invention extends to any novel aspects or features described and/or illustrated herein.

In this specification the word ‘or’ can be interpreted in the exclusive or inclusive sense unless stated otherwise.

Furthermore, features implemented in hardware may generally be implemented in software, and vice versa. Any reference to software and hardware features herein should be construed accordingly.

Whilst the invention has been described in the field of domestic food processing and preparation appliances, it can also be implemented in any field of use where efficient, effective and convenient preparation and/or processing of material is desired, either on an industrial scale and/or in small amounts. The field of use includes the preparation and/or processing of: chemicals; pharmaceuticals; paints; building materials; clothing materials; agricultural and/or veterinary feeds and/or treatments, including fertilisers, grain and other agricultural and/or veterinary products; oils; fuels; dyes; cosmetics; plastics; tars; finishes; waxes; varnishes; beverages; medical and/or biological research materials; solders; alloys; effluent; and/or other substances. Any reference to “food”, “beverage” (or similar language) herein may be replaced by such working mediums.

The invention described here may be used in any appliance, such as a kitchen appliance, and/or as a stand-alone device. This includes any domestic food-processing and/or preparation appliance, including both top-driven appliances (e.g., stand-mixers) and bottom-driven appliances (e.g., food processors). It may be implemented in heated and/or cooled appliances. The invention may also be implemented in both hand-held (e.g., hand blenders) and table-top (e.g., blenders) appliances. It may be used in an appliance that is built-in to a work-top or work surface, or in a stand-alone device. The invention can also be provided as a stand-alone device, whether motor-driven or manually powered.

“Food processing” as described herein should be taken to encompass chopping, whisking, stirring, kneading, mincing, grinding, shaping, shredding, grating, cooking, freezing, making ice-cream, juicing (centrifugally or with a scroll), or other food-processing activities involving the physical and/or chemical transformation of food and/or beverage material by mechanical, chemical, and/or thermal means. “Food processing attachment” encompasses any attachable component configured, for example on rotation and/or energising, to carry out any of the previously described food processing tasks.

### BRIEF DESCRIPTION OF DRAWINGS

One or more aspects will now be described, by way of example only and with reference to the accompanying drawings having like-reference numerals, in which:

FIG. 1 is a side-on view of a food processing attachment according to a first embodiment of the present invention;

FIG. 2 is a side-on, exploded view of the food processing attachment of FIG. 1;

FIG. 3 is a perspective view of the container of the attachment of FIG. 1;

FIG. 4a shows a side-on cut-away drawing through the section A-A of FIG. 1 with the attachment at a first orientation;

FIG. 4b shows a side-on cut-away drawing along a different section to that of A-A with the attachment at a second orientation;

FIG. 5 shows the attachment of FIG. 4b with a food processing tool attached;

FIG. 6 shows a food processing attachment according to another embodiment of the present invention;

FIG. 7 shows a side-on, cut-away view of the food processing attachment of FIG. 6 along the section B-B;

FIG. 8 shows a side-on, exploded view of the food processing attachment of FIG. 6;

FIG. 9 shows a side-on view of the wiper assembly of the food processing assembly of FIG. 6;

FIG. 10 shows a side-on cut-away view of the wiper assembly of FIG. 9 along the section C-C;

FIG. 11 shows a side-on view of the food processing attachment of FIG. 6 with a motor unit attached thereto; and

FIG. 12 shows a side-on view of the food processing attachment and motor unit of FIG. 11 without a container.

### SPECIFIC DESCRIPTION

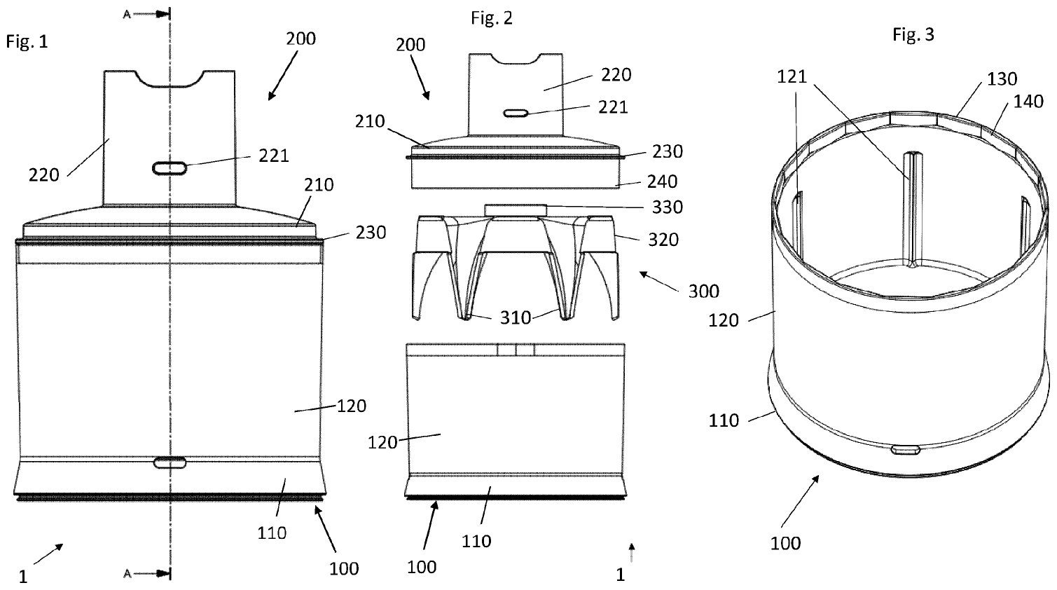

FIGS. 1, 2, and 3 show an exemplary embodiment of the present invention. A food processing attachment/assembly 1 comprising a container 100, a lid 200, and a wiper assembly/module (i.e. a “wiper”) 300 is shown.

The container 100 has a base 110 that may be substantially circular in plan. A substantially cylindrical side-wall 120 extends upwardly from the base 110 to partially enclose a substantially cylindrical space. Ribs 121 extend axially/vertically along a major axis of the container along an inner surface of the side-wall 120. The ribs 121 may be integrally formed with the container 100 or may be separate elements attached by gluing or clipping.

The side-wall 120 of the container 100 is closed at the opposite end to the base 110 by a lid 200 that is releasably-attachable to the container 100. The lid 200 has a flange 210 that extends across the opening formed by the side-wall 120. The lid 200 receives a drive (e.g. from a motor unit) for driving a tool within the container 100. A motor-unit mounting-point 220 is provided on an exterior surface of the lid 200 for mounting a motor unit on the lid to drive tools within the container 100 to process food. To prevent the lid 200 being completely inserted into the container 100 the lid 200 has a rim 230 having a wider diameter than the aperture of the container 100, such that when the lid 200 is inserted into the container 100 the rim 230 rests on the side-wall 120. The lid 200 also has a skirt 240 that may include a seal (e.g., a rubber gasket) that seals any gap between the lid 200 and the container 100. Additionally or alternatively to the use of the rim 230, the skirt 240 may rest on top of the ribs 121 or on an inward-extending rim of the container 100 to prevent complete insertion of the lid 200 into the container 100.

A wiper assembly 300 is provided attached (either releasably or fixed) to the lid 200. The wiper assembly 300 has wipers/arms 310 extending axially from the lid 200 towards the base 110 along the inside surface of the side-wall 120. The wipers 310 are provided extending from a circular carriage 320 (i.e. a base plate) which is preferably rigid. The circular carriage 320 may attach to the lid peripherally via e.g., snap-elements, or centrally via a central element 330. The central element 330 may bear against the lid 200, for example against a suitable protrusion or indent, to fix the wiper assembly 300 radially and/or axially during rotation.

The wipers 310 may be one or more in number, but are preferably three or more for balancing. The wipers 310 may be located symmetrically about the wiper assembly 300 to improve balancing. Each wiper arm 310 rotates between two adjacent ribs 121—thus, the ribs 121 act as ‘restricting elements’ that restrict rotation of the wiper arms 310. Preferably at least one wiper 310 extends into each gap between the ribs 121 so that each gap can be wiped simultaneously. The number of wipers 310 may be equal to the number of ribs 121 so that each wiper 310 is matched with a rib 121. The wipers 310 may be six in number.

The wipers 310 may either be rotatable relative to the lid 200, or non-rotatable relative to the lid 200 (i.e. rotationally fixed to the lid 200). For example the wiper assembly 300 may be drivable to rotate using a rotatable element on the lid 200, for example a rotatable knob attached to a gear that interfaces with teeth on the wiper assembly 300. Alternatively the central element 330 may extend partly outside the lid 200 so as to be driveable (e.g., a portion of the surface of the central element 330 may be accessible through a hole in the lid 200). In a further alternative the wiper assembly 300 is rotationally fixed relative to the lid 200, such that the wiper assembly 300 may be rotated by rotating the lid 200 or by rotating the attached motor-unit, which itself is rotationally fixed relative to the lid on the mounting point 220. Rotating the wiper assembly 300 through the motor-unit is especially advantageous, because it requires no additional control elements and can be done intuitively by the user with the same hand that is operating the motor unit as a one-hand operation. However the wiper assembly 300 is rotated, when it is rotated within the container 100, the wipers 310 wipe down the internal surface of the side-wall 120 moving food material downwardly back towards the base 110 for processing.

In the present example, the arms 310 are attached to, and rotate with, the base plate 320. Alternatively, the arms 310 may be rotatable relative to the base plate 320, which in turn may be rotationally fixed to the container 100 and/or lid 200.

The wipers 310 can be hollow (for example, have an axial groove formed in them facing the inner surface of the side-wall 120) so as to receive the ribs 121 within them, such that when the wipers 310 are located over the ribs 121 the wiper assembly 300 cannot be rotated relative to the container 100. As such the wipers 310 may be rotationally fixed relative to the container 100 by sliding them axially over the ribs 121 when inserting the combined lid 200 and wiper assembly 300 into the container 100 so as to seal the open end of the container 100. Making the wipers 310 hollow also has the advantage of rendering the wipers assembly 300 lighter.

The wipers 310 are preferably shaped to urge food material flowing along the inner surface of the side-wall 120 axially back towards the base 110 and/or radially back towards the centre of the container 100. For example, they may slope inwardly, extending further radially towards the centre of the lid 200, and additionally or alternatively taper towards their clockwise and/or anti-clockwise edge. The wipers 310 preferably taper into the side-wall 120 towards the base 110. The ribs 121 may be similarly shaped to urge material flowing along the side-wall 120 towards the centre of the container 100.

The wipers 310 may be made of a flexible material. For example, they may be made of a flexible plastic, or artificial or synthetic rubber. Alternatively, they may be made of a rigid material such as a hard moulded plastic or metal, and the rigid wipers 310 may have a flexible sealing edge that abuts the container 100 when the wiper assembly 300 is inserted into the container 100. Use of a flexible material enhances wiping, and also allows the wipers 310 to wipe closely to the ribs 121, as the wipers 310 may conform to the ribs 121 and squeeze up against them to wipe close to them or even wipe them. The wipers 310 can consist of rigid frame-elements made of, for example, a hard plastic, with flexible, resilient wiper-elements made of, for example, synthetic rubber, attached along a length of the frame-elements by e.g. gluing or over-moulding. Alternatively they may be made entirely of a flexible material. Having a two-part construction to the wipers 310 allows the wipers 310 to have the advantage both of rigid frame-elements holding the wipers 310 firmly along the inside of the sidewall 120, and the flexibility of the wiper-elements for better wiping. Having a single-piece construction simplifies manufacture. Where the wipers 310 have a partly-rigid construction, the above-mentioned grooves in which the ribs 121 are received is preferably provided in the rigid part for secure attachment.

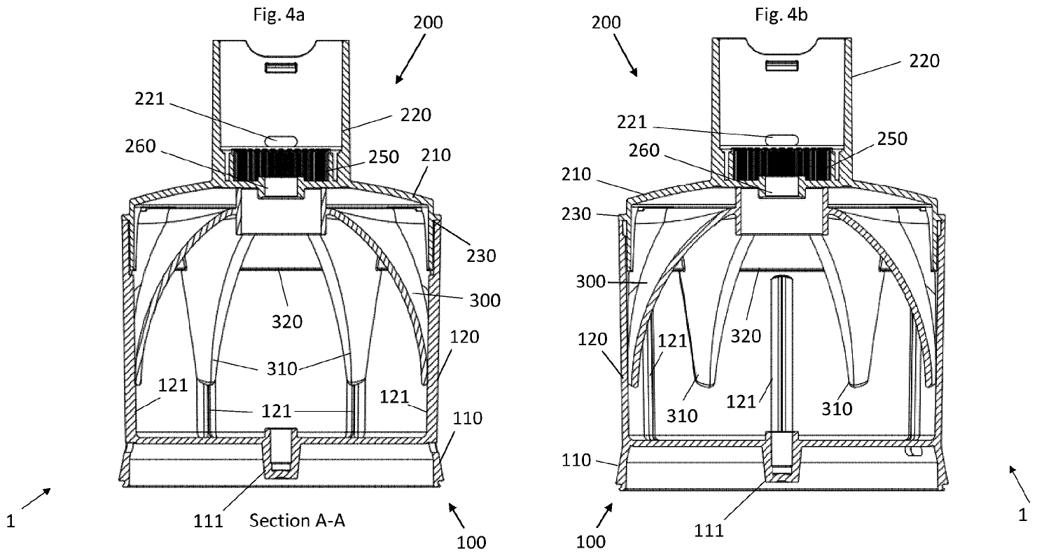

FIGS. 4a and 4b show the tool/food processing attachment 1 in two different configurations. In the first configuration shown in FIG. 4a, the wipers 310 are located covering and rotationally-fixed relative to the ribs 121 (shown as an increased thickness of the side-wall 120). In this configuration the wipers 310 serve to urge food material flowing over the inner surface of the side-wall 120 inwardly and downwardly.

In the second configuration of FIG. 4b the wipers 310 are located between the ribs 121. In this configuration the wipers 310 can move rotationally relative to the container 100 to wipe down the internal surface of the side-wall 120, moving material towards the base 110 for processing by a tool there. However, the rotational arc of the wipers 310 is limited by the ribs 121 such that the wipers 310 cannot rotate past them, meaning that the wipers 310 cannot be driven to rotate by the action of the rotary tool within the container 100 past the ribs 121 and continuous undesired rotation of the wipers 310 is thus avoided.

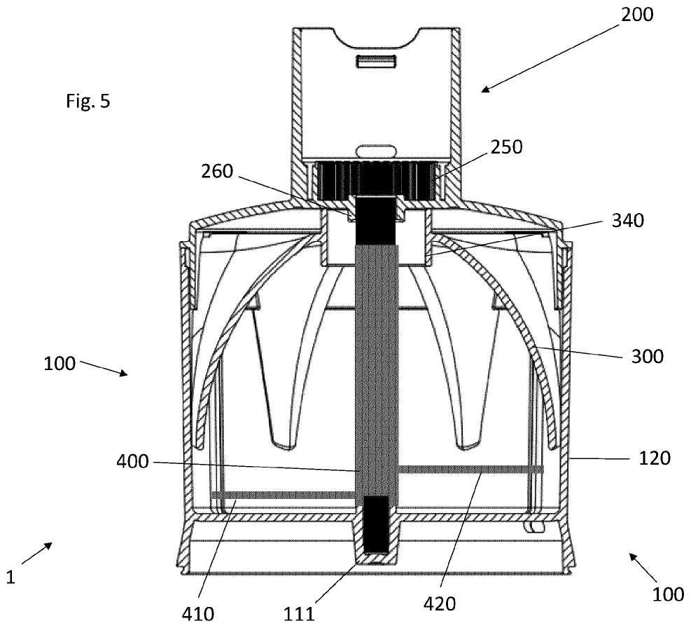

As can be seen in FIG. 5, the motor unit attachment point 220 has gearing 250 within it to which a motor can be attached to drive a tool 400 to carry out processing within the container 100 with its two (or more) radially-extending blades/paddles 410 and 420, which may be of differing height above the base 110 to carry out processing at different heights. The tool 400 can be located in a bearing 111 of the base 110 of the container 100 at its lower end, and at its upper end attached to a drive outlet 260 of the lid 200 to receive rotational drive. The tool 400 extends through an aperture 340 in the wiper assembly 300. The blades/paddles 410 and 420 preferably extend lower than the wipers 310 so as not to interfere with them. Particularly, food material moved inwardly/downwardly by the wipers 310 and ribs 121 is moved towards the blades/paddles 410 and 420 for processing.

The motor unit may be releasably attached within the attachment point 220 using, for example, inwardly-extending spring-loaded tabs that can be actuated to release using an external button or buttons. A hole 221 is also provided in the attachment point 220 to allow water to drain therefrom during e.g. cleaning.

Whilst the attachment of FIG. 1 is described as having an attachable motor unit, that attaches to the lid 200 using the attachment point 220, it may alternatively or additionally attach to a base unit which drives the tool 400 through the base 110. In a further alternative, the attachment 1 may include an integral motor, for example in the base 110 or in the lid 200, for driving the tool 400.

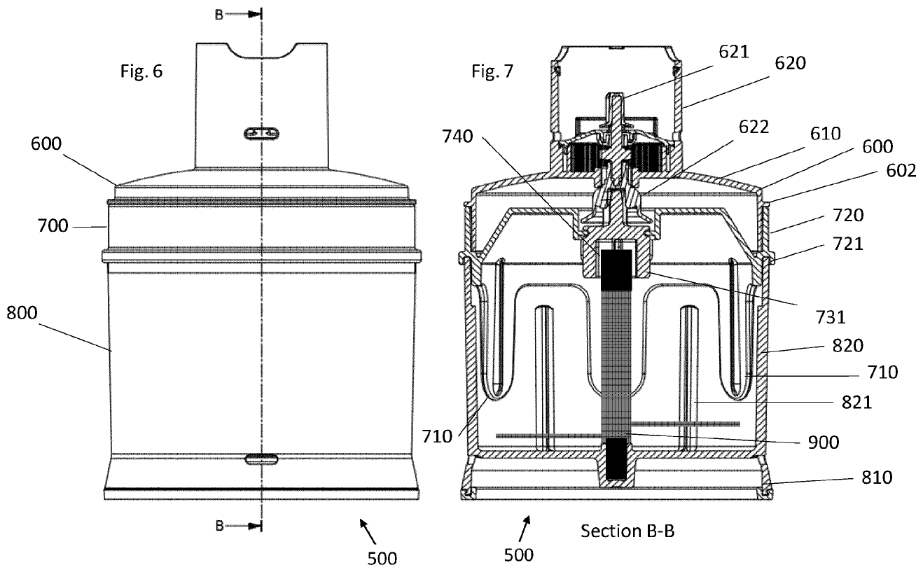

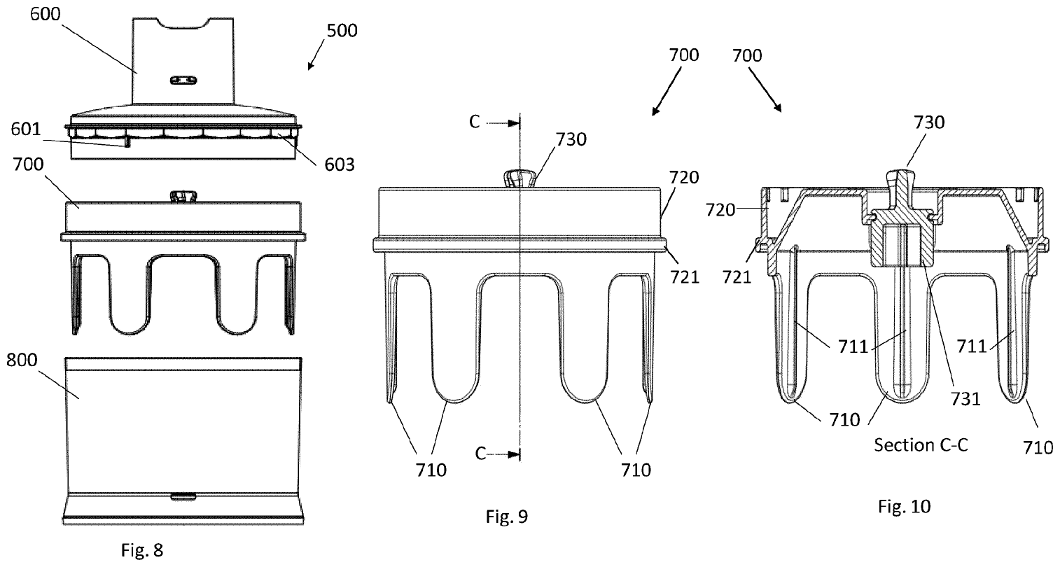

FIGS. 6-8 and 11-12 illustrate a food processing attachment/assembly 500 according to another embodiment of the invention identical to the attachment of FIG. 1 except as described in the following description.

The food processing attachment 500 includes a lid 600, a container 800, and a wiper assembly 700 located between the lid 600 and the container 800. The lid 600 is identical to the lid 200 except that it includes locating tabs 601 and a polygon section 603 which can be inserted into corresponding recesses in either the wiper assembly 700 or container 800 to fix the lid rotationally relative thereto. The container 800 is also identical to the container 100, including a base 810 and a side-wall 820 having inwardly-protruding ribs 821 extending along a surface thereof.

In the present example, in use, the wiper 700 is attached on top of the container 800 (and preferably seals the container 800), and the lid 600 is attached onto the wiper 700. The lid 600 is rotationally fixed relative to the wiper 700 (so arranged to rotate with the wiper 700), and the wiper 700 and the lid 600 are rotatable on the container 800 by a specific angle determined by the number of ribs 821 in the bowl 800.

The wiper assembly 700 is removably locatable within the container 800 and rotatable relative thereto to wipe the inner surface of the side-wall 820 of the container 800. The wiper 700 has arms 710 extending axially from a circular carriage (i.e. base plate) 720 such that, when the wiper assembly 700 is located within the container 800, the arms 710 extend alongside the side-wall 820 such that when the wiper assembly 700 is rotated the inner surface of the side-wall 820 is wiped by the arms 710.

The arms 710 may be rigid so as to only wipe between the ribs 821, or may be flexible so as to be able to wipe over the ribs 821. The arms 710 may also be shaped to conform to the side-wall 820 of the container 800, for example they may be curved so as to conform to a circular-cylindrical side-wall by e.g., having an arcuate cross-section.

The wiper assembly 700 is prevented from being inserted entirely into the container 800 by a lip 721 that extends radially outwardly from the circular carriage 720 so as to over-lie the open end of the cylindrical top wall 820 of the container 800. In this way the container 800 may also be sealed by the wiper assembly 700. The arms 710 may also be shaped such that when rotated about their main axis they push food material on the side-wall 820 axially towards the base 810 such that it pools there to be further processed by the tool 900. The circular carriage 720 may form a side-wall on which a radially-extending lip 602 of the lid 600 rests, thus locating the lid 600 relative to the wiper assembly 700.

As the lid 600 may be fixed relative to the wiper assembly 700 by the tabs 601 or the polygon section 603, rotation of the lid 600 can directly actuate the wiper assembly 700 to rotate and wipe. This can be done by inserting a handle-shaped motor unit 1000 into the motor-unit attachment point 620 attached to the radially-extending flange-shaped portion 610 of the lid 600, and rotating the motor unit 1000. Thus food sprayed onto the side-wall 820 by the tool 900 rotating within the container 800 can be wiped downwards for further processing by the tool 900 without having to open the container 800 or stop the processing of food.

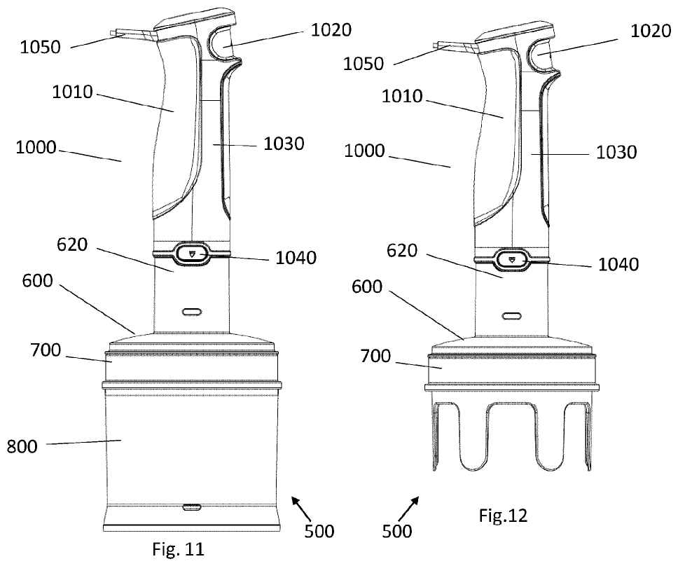

FIG. 11 shows the food processing assembly 500 of FIGS. 6-8 with a motor unit 1000 attached to the motor unit attachment-point 620 via inwardly-extending spring-loaded tabs (not shown) that can be actuated to release using a release button 1040. FIG. 12 shows the same assembly 500, but with the container 800 removed. The motor unit 1000 comprises: a main body 1030 that houses a drive (not shown) for the attachment 500, a handle portion 1010 shaped to receive the user's hand, a power cord 1050, the release button 1040, and a speed button 1020 for actuating the drive of the motor unit 1000 that can be actuated by one of the user's fingers. The motor unit 1000 is received by the motor unit attachment point 620 in a rotationally fixed way. The lid 600 and wiper 700 can thus be rotated relative to the container 800 by rotating the motor unit 1000. The user can therefore use the same hand holding an operating the motor unit 1000 (i.e. the hand holding the handle portion 1010 and/or the motor unit main body 1030) to wipe the inner wall of the container 800 in a convenient and intuitive one-hand operation, and no additional hand or actuation feature is needed to control the rotation of the wiper 700.

FIGS. 9 and 10 show further details of the wiper assembly 700. As shown in FIG. 10, the arms 710 can include axially-extending strengtheners 711 to provide greater axial strength such that the arms 710 are held in contact with the side-walls 820. Additionally, in order for a motor-unit in the attachment-point 620 to drive the tool 900, a drive-extension 730 is provided. The drive extension 730 has an upper end shaped to fit a drive outlet of the lid 622, which in return receives drive from the motor unit 1000 via a shaft 621 shaped to engage with a drive-outlet of the motor unit 1000. The drive extension 730 in turn has its own drive outlet 731 which is shaped to receive the tool 900 within it to receive drive (i.e. the drive extension 730 of the wiper 700 comprises an aperture 740 shaped to receive the tool 900). For example, the drive outlet 731 may comprise a hexagonal-shaped recess 740 which receives a hexagonal shaft of the tool 900.

The wiper assembly 700 with the drive extension 730 also serves as an intermediate lid, separating the lid 600 from the processed food items. This prevents the coating of the lid 600 with food particles and eliminates or greatly reduces the need for cleaning of the lid 600. Instead only dishwasher-safe wiper assembly 700 needs to be cleaned. The wiper 700 completely prevents contact of the food processed in the container 800 with the lid 600 because the wiper 700 is attached onto the container 800 (prior to attachment of the lid 600 to the wiper 700), and the base plate 720 and the drive extension 730 separate the container 800 from the lid 600. This simplifies cleaning of the attachment 500, as it removes the need for cleaning the (typically non-dishwasher-safe, especially if it receives drive) lid 600 and only requires cleaning of the (typically dishwasher-safe) wiper 700. The arms 710 of wiper 700 do not comprise recesses/cavities for locking the arms 710 over the ribs 821, and the arms 710 are instead flat. This allows preventing collection of food residue in/behind the arms 710, and minimizes the wastage of food

The wiper 700 can be fixed relative to the container 800 by rotating the arms 710 to come in contact with (i.e. touch) the ribs 821 at the limit of the arms' 710 rotation angle, defined by the ribs 821.

As used herein, the term “removable attachment” (and similar terms such as “removably attachable”), as used in relation to an attachment between a first object and a second object, preferably connotes that the first object is attached to the second object and can be detached (and preferably re-attached, detached again, and so on, repetitively), and/or that the first object may be removed from the second object without damaging the first object or the second object; more preferably the term connotes that the first object may be re-attached to the second object without damaging the first object or the second object, and/or that the first object may be removed from (and optionally also re-attached to) the second object by hand and/or without the use of tools (e.g. screwdrivers, spanners, etc.). Mechanisms such as a snap-fit, a bayonet attachment, and a hand-rotatable locking nut may be used in this regard.

As used herein, the term “processing” preferably connotes any action relating to or contributing towards transforming products into foodstuff, or transforming foodstuff into a different form of foodstuff, including—as examples—applying mechanical work (e.g. for cutting, beating, blending, whisking, dicing, spiralising, grinding, extruding, shaping, kneading etc.) and applying heat or cold. “Food” and “foodstuff” as used herein can include beverages and frozen material and material used in creating them (e.g., coffee beans).

“Food safe” in this context means any substance that does not shed substances harmful to human health in clinically significant quantities if ingested. For example, it should be BPA-free.

“Dishwasher safe” means that it should be physically and chemically stable during prolonged exposure to the conditions prevailing within a dishwasher machine. For example it should be able to withstand exposure to a mixture of water and a typical dishwasher substance (e.g., washing with Fairy™ or Finish™ dishwasher tablets and water, at temperatures of 82 degrees Centigrade for as long as 8 hours without visibly degrading (e.g., cracking)).

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

The following lists a number of aspects:
1. A food processing container assembly comprising a container, a lid releasably attachable to the container so as to substantially seal it, and a wiper assembly rotatable to wipe an inner wall of the container, wherein in a first configuration the lid is attached directly to the container, and in a second configuration the wiper assembly is located between the lid and the container and the wiper assembly is actuatable to rotate through the lid.
2. The food processing container assembly of aspect 1, wherein the wiper assembly comprises two or more axially-extending arms.
3. The food processing container assembly of aspect 2, wherein the container comprises ribs extending axially along an inner surface thereof, and the arms, in the second configuration, extend between the ribs to wipe therebetween, and preferably wherein the number of arms is equal to the number of ribs.
4. The food processing container assembly of any one of aspects 2-3, wherein the arms comprise resilient wipers mounted on rigid frame-elements.
5. The food processing container assembly of any one of aspects 2-4, wherein the arms comprise recesses configured to receive the ribs to lock therewith.
6. The food processing container assembly of any one of aspects 2-5, wherein the arms are shaped and configured such that food material encountering the arms is directed radially and/or axially away from the arms.
7. The food processing container assembly of any one of aspects 2-6, wherein the arms are at least three in number, and more preferably are six in number.
8. The food processing container assembly of any one of aspects 2-7, wherein the arms are arrayed/arranged symmetrically about the lid.
9. The food processing container assembly of any preceding aspect, wherein the arms are provided on a carriage of the wiper assembly, and wherein the carriage is releasably attachable to the lid.
10. The food processing container assembly of any preceding aspect, wherein the wiper assembly is actuatable to rotate relative to the lid from an opposite side of the lid to the wiper assembly.
11. The food processing container assembly of any preceding aspect, wherein the lid further comprises a motor-unit attachment point, and a shaft and/or gearing configured for transmitting drive impetus from a motor unit mounted in the motor-unit attachment point to a tool located on an opposite side of the lid to the motor-unit attachment point.
12. The food processing container assembly of aspect 11, wherein the wiper assembly is actuatable to rotate via the motor-unit attachment point.
13. The food processing container assembly of aspect 11, wherein the motor-unit attachment point comprises releasable-attachment means for releasably attaching a motor-unit thereto.
14. The food processing container assembly of any preceding aspect, further comprising a rotary tool removably attachable to the container and/or lid.
15. A food processing device comprising the food processing container assembly of any preceding aspect.

1-25. (canceled)

26. A food processing assembly comprising: a lid for a container, wherein the lid is adapted to receive a drive for driving a tool within the container; and a wiper for wiping an inner wall of the container.

27. The assembly of claim 26, wherein the wiper includes an aperture for receiving the tool and/or the drive.

28. The assembly of claim 26, wherein the wiper includes a drive extension adapted to transmit drive between the lid and the tool.

29. The assembly of claim 28, wherein the drive extension is arranged to cover the aperture.

30. The assembly of claim 26, wherein the wiper is rotatable to wipe the inner wall of the container.

31. The assembly of claim 30, wherein the wiper is rotatable with the lid for wiping the inner wall of the container; preferably the wiper is rotatable by rotating the drive a means for driving the tool, received by the lid.

32. The assembly of claim 26, the assembly further comprising the container, preferably wherein the arrangement is such that rotation of the wiper relative to the container is restricted.

33. The assembly of claim 32, wherein the container comprises one or more elements for restricting rotation of the wiper relative to the container, preferably wherein the restricting element comprises a rib on an inner wall of the container arranged to engage with the wiper, and/or wherein the arrangement is such that the angle over which the wiper can rotate is limited.

34. The assembly of claim 32, wherein the wiper is configurable between a fixed configuration in which the wiper is rotationally fixed relative to the container, and a rotating configuration in which the wiper is rotatable relative to the container.

35. The assembly of claim 26, the assembly further comprising the tool; preferably wherein the wiper is adapted to permit driving of the tool when the wiper is in the container.

36. The assembly of claim 26, the assembly further comprising the drive; preferably wherein the drive is located on the lid.

37. The assembly of claim 26, wherein the wiper is removably attachable to the lid, and wherein the wiper is adapted to cover an inner surface of the lid from the container.

38. The assembly of claim 26, wherein the wiper is removably attachable to the container, preferably wherein the wiper is adapted to seal the container.

39. The assembly of claim 26, wherein the wiper includes a base plate, optionally wherein the base plate is adapted to cover the inner surface of the lid from the container.

40. The assembly of claim 39, wherein the wiper includes one or more arms for wiping an inner wall of the container, preferably wherein the arms extend from the base plate and preferably wherein the wiper includes two or more arms, preferably three or more, more preferably six arms; preferably wherein the arms are arranged symmetrically around the wiper.

41. The assembly of claim 40, wherein the arms are flexible; optionally wherein each arm comprises a rigid frame and a flexible element for wiping the inner wall of the container, and/or wherein the arms are flat.

42. The assembly of claim 40, wherein an, preferably each, arm is adapted to engage with an engagement formation on the container to restrict movement, preferably rotation, of the wiper relative to the container.

43. The assembly of claim 40, wherein the arms are further adapted to act as ribs for the container.

44. A wiper for wiping an inner wall of a container having a lid, the wiper being removably attachable to the lid, and being adapted to cover an inner surface of the lid from the container; preferably wherein the wiper is the wiper of claim 38.

45. A food processing device comprising the food processing assembly of claim 26.
